(19) United States
(12) Patent Application Publication
(10) Pub. No.: US 2015/0093652 A1
(43) Pub. Date: Apr. 2, 2015

(54) SULFIDE SOLID ELECTROLYTE, METHOD OF PREPARING THE SAME, AND SOLID STATE BATTERY INCLUDING THE SAME

(71) Applicant: Samsung Electronics Co., Ltd., Suwon-si (KR)

(72) Inventors: Yuich AIHARA, Yokohama-city (JP); Nobuya MACHIDA, Kobe (JP); Seitaro ITO, Yokohama-city (JP)

(21) Appl. No.: 14/504,611

(22) Filed: Oct. 2, 2014

(30) Foreign Application Priority Data
Oct. 2, 2013 (JP) 2013-207312
Jun. 10, 2014 (JP) 2014-119413
Jul. 7, 2014 (KR) 10-2014-0084621
Sep. 30, 2014 (KR) 10-2014-0131428

(51) Int. Cl. H01M 10/0562; C01B 25/14; H01M 10/0525

(52) U.S. Cl. CPC H01M 10/0562; H01M 10/0525; C01B 25/14; C01P 2006/40; H01M 2300/002
USPC 429/322; 423/303

(57) ABSTRACT

A sulfide solid electrolyte including a sulfide product prepared by mixing at least Li₂S and P₂S₅ in an organic solvent, wherein the organic solvent includes a tetrahydrofuran compound optionally substituted with a C1-C6 hydrocarbon group or a C1-C6 hydrocarbon group including an ether group, or a C2-C7 non-cyclic ether compound.

### CROSS-REFERENCE TO RELATED APPLICATIONS

This application claims priority to Japanese Patent Application No. 2013-207312, filed on Oct. 2, 2013, and Japanese Patent Application No. 2014-119413, filed on Jun. 10, 2014 in the Japanese Patent Office, and Korean Patent Application No. 10-2014-C084621, filed on Jul. 7, 2014, and Korean Patent Application No. 10-2014-0131428, filed on Sep. 30, 2014, in the Korean Intellectual Property Office, and all the benefits accruing therefrom under 35 U.S.C. §119, the contents of all of which are incorporated herein in their entirety by reference.

### BACKGROUND

1. Field

The present disclosure relates to sulfide solid electrolytes prepared using an organic solvent, methods of preparing the same, and solid state batteries employing the sulfide solid electrolytes.

2. Description of the Related Art

Because of the high energy density, lithium-ion secondary batteries have been used in electric automobiles, personal digital assistants, and the like. Research is being conducted on solid electrolytes having high ion conductivity to improve performance and safety of lithium-ion secondary batteries. Sulfide solid electrolytes, which have a transport number of lithium ions of 1 and an ion conductivity of about 10⁻⁴ S/cm, have drawn attention as solid electrolytes contribute to improve battery performance.

Conventional methods of manufacturing sulfide solid electrolytes include a melt quenching method and a solid phase reaction. The melt quenching method is a method of preparing a sulfide solid electrolyte by quenching a melt of materials such as Li₂S and P₂S₅. However, the sulfide solid electrolyte obtained by the melt quenching method often lacks stable composition due to the effect of pyrolyzed gases generated during a melting process. In addition, bulk form of sulfide is produced, and thus a pulverization process is required to use the sulfide as a solid electrolyte.

Examples of the solid phase reaction include a mechanical milling (MM) method. According to the MM method, starting materials and balls are added to a ball mill, and the starting materials are ground and mixed by using strong vibrations applied thereto. Japanese Patent Application Laid-Open Publication No. Hei 11-134937 and Japanese Patent Application Laid-Open Publication No. 2002-109955 disclose methods of preparing sulfides by using the MM method. However, since the MM method is performed using a specific device, it is difficult to scale up the production of the sulfides by using this method. In addition, since a substantial amount of energy is used to operate the device and the MM method is a time consuming process, manufacturing costs may increase. Thus, it is difficult to apply the MM method to industrial production of the sulfides.

As another method of preparing a sulfide solid electrolyte, a method of synthesizing a sulfide solid electrolyte by stirring Li₂S and P₂S₅ in an organic solvent (solution method) has been proposed recently. Journal of the American Chemical Society 2013, 135, 975-978 discloses a solution method using tetrahydrofuran (THF) as an organic solvent. However, when crystalline Li₃PS₄ is obtained by the solution method using THF as a solvent, the crystalline Li₃PS₄ has very low ion conductivity of about 10⁻⁷ S/cm. Journal of Power Sources 2013, 224, 225-229 discloses a solution method using hydrazine. In addition, Proceedings of the Electrochemical Society of Japan, 80th spring meeting, 2013, 3H25 part, discloses a method of precipitating a sulfide solid electrolyte by dissolving the sulfide solid electrolyte, which is synthesized by a solid phase reaction using a ball mill, in N-methyl formamide (NMF).

As examples of the solvent used in the solution method, a hydrocarbon organic solvent such as toluene (Japanese Patent Application Laid-Open Publication No. 2010-140893 and Japanese Patent Application Laid-Open Publication No. 2010-186744) and an aprotic organic solvent such as N-methyl pyrrolidone (NMP) (WO2004/093099) have been reported. However, when a less-volatile organic solvent such as NMP is used, the organic solvent tends to remain in the sulfide. In this case, ion conductivity of the sulfide becomes reduced, and thus the sulfide is not suitable for the solid electrolyte.

Thus, there remains a need for a sulfide solid electrolyte having high conductivity, which can be produced on a large scale with low manufacturing costs.

### SUMMARY

Provided are sulfide solid electrolytes that can be produced on a large scale with low manufacturing costs and have high ion conductivity.

Provided are methods of producing sulfide solid electrolytes having high ion conductivity on a mass production scale and low manufacturing costs.

Provided are solid state batteries including the sulfide solid electrolyte.

Additional aspects will be set forth in part in the description which follows and, in part, will be apparent from the description, or may be learned by practice of the presented embodiments.

According to an aspect, a sulfide solid electrolyte includes a sulfide product prepared by mixing at least Li₂S and P₂S₅ in an organic solvent including a tetrahydrofuran compound optionally substituted with a C1-C6 hydrocarbon group or a C1-C6 hydrocarbon group containing an ether group, or a C2-C7 non-cyclic ether compound.

According to an embodiment, the sulfide product may be an amorphous sulfide product obtained by mixing at least Li₂S and P₂S₅ in a mixture of the organic solvent and an amorphization solvent.

According to another embodiment, the sulfide solid electrolyte may contain an amorphous sulfide product obtained by further mixing the sulfide solid electrolyte in an amorphization solvent. Alternatively, the sulfide solid electrolyte may contain an amorphous sulfide product obtained by removing the organic solvent from the sulfide solid electrolyte, and further mixing the sulfide solid electrolyte in an amorphization solvent. The amorphization solvent may be a compound which has a donor number from 18 to 28, and a boiling point which is equal to the boiling point of the organic solvent or higher than the boiling point of the organic solvent. For example, the amorphization solvent may be at least one selected from dimethoxy ethane, diethoxy ethane, and anisole. According to an embodiment, the sulfide solid electrolyte may contain a sulfide product obtained by heat treating the sulfide product at a temperature of about 50 to 200° C. for about 30 to 180 minutes. According to another embodiment, the sulfide solid electrolyte may contain a crystalline sulfide product obtained by heat treating the sulfide product at a temperature of about 50 to 200° C. for about 30 to 180 minutes, and, thereafter, further heat treating the sulfide product at a temperature of about 180 to 350° C. for about 30 to 180 minutes.

The sulfide product may further include at least one selected from GeS₂, SiS₂, P₂S₃, P₂O₅, Si0₂, B₂S₃, B₂O₃, Al₂S₃, and Al₂S₅.

According to another aspect, a method of preparing a sulfide solid electrolyte includes

mixing at least Li₂S and P₂S₅ in an organic solvent, wherein the organic solvent includes a tetrahydrofuran compound optionally substituted with a C1-C6 hydrocarbon group or a C1-C6 hydrocarbon group containing an ether group, or a C2-C7 non-cyclic ether compound, to obtain a sulfide product; and

removing the organic solvent from the sulfide product by drying the sulfide product.

According to another embodiment, the mixing at least Li₂S and P₂S₅ in an organic solvent may include mixing at least Li₂S and P₂S₅ with a combination of the organic solvent and an amorphization solvent added to the organic solvent. Alternatively, between the mixing and the solvent-removing, the method may further include amorphization by contacting the sulfide product with an amorphization solvent to obtain an amorphous sulfide product. The amorphization solvent may be a compound which has a donor number from 18 to 28, and a boiling point which is equal to or greater than the boiling point of the organic solvent. For example, the amorphization solvent may be at least one selected from dimethoxy ethane, diethoxy ethane, and anisole.

According to another embodiment, the amorphization by contacting the sulfide product with an amorphization solvent may be preceded by removing the organic solvent from the sulfide product, wherein the organic solvent is distilled out from the sulfide product after the mixing.

According to an embodiment, the removing the organic solvent from the sulfide product may include a heat-treating the sulfide product in vacuum, wherein the sulfide product is calcined at a temperature in the range of about 50 to about 200° C. for about 30 to about 180 minutes.

According to another embodiment, the method may further include a crystallizing the sulfide product from the organic solvent, wherein the sulfide product after the solvent-removing is calcined at a temperature in the range of about 180 to about 350° C. for about 30 to about 180 minutes.

The sulfide solid electrolyte may include the tetrahydrofuran compound or the C2-C7 non-cyclic ether compound optionally substituted with a C1-C6 hydrocarbon group or a C1-C6 hydrocarbon group in an amount detectable by at least one analysis method selected from nuclear magnetic resonance (NMR) spectroscopy, infrared (IR) spectroscopy, elemental analysis (EA) , and gas chromatography-mass spectrometry (GC-MS).

The tetrahydrofuran compound may be a tetrahydrofuran derivative represented by Formula 1:

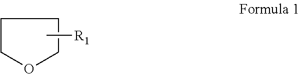

wherein R₁ is a C1-C6 alkyl group or an —X—O—Y group, wherein X is a C0-C3 alkylene group, and Y is a C1-C3 alkyl group.

The C2-C7 non-cyclic ether compound may be represented by Formula 2:

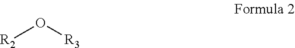

wherein R₂ and R₃ are each independently a C1-C3 alkyl group, a C3-C5 cycloalkyl group, phenyl group, or an —X′—O—Y′ group, wherein X′ is a C1-C3 alkylene group, and Y′ is a C1-C3 alkyl group, provided that R₂ and R₃ are not simultaneously the —X′—O—Y′ group.

The sulfide product may have an ion conductivity of about 10⁻⁵ to about 10⁻² siemens per centimeter (S/cm) after the organic solvent-removing.

The sulfide product may be an amorphous material or a crystalline material including at least one selected from Li₃PS₄, Li₄P₂S₆, Li₄P₂S₇, and Li₇P₃S₁₁.

In the mixing, a molar ratio of Li₂S to P₂S₅ added to the organic solvent may be x:1-x, wherein x is any number satisfying the condition of 0.1<x<0.9.

At least one selected from GeS₂, SiS₂, P₂S₃, P₂O₅, SiO₂, B₂S₃, Al₂S₃, B₂O₃ and Al₂S₅ may further be added to the organic solvent.

According to another aspect, a solid state battery includes a positive electrode including a positive active material, a negative electrode including a negative active material, and a solid electrolyte layer interposed between the positive electrode and the negative electrode, wherein the solid electrolyte layer includes the sulfide solid electrolyte described above.

The solid state battery may be an all-solid-state secondary battery.

### BRIEF DESCRIPTION OF THE DRAWINGS

These and/or other aspects will become apparent and more readily appreciated from the following description of the embodiments, taken in conjunction with the accompanying drawing in which:

FIG. 1 represents a flowchart of a method of preparing a sulfide solid electrolyte, according to an embodiment.

FIG. 2 represents a flowchart of a method of preparing a sulfide solid electrolyte, according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. The term “or” means “and/or.” Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “hydrocarbon group” refers to a group derived from an organic compound having at least one carbon atom and at least one hydrogen atom, optionally substituted with one or more substituents where indicated.

### An Embodiment

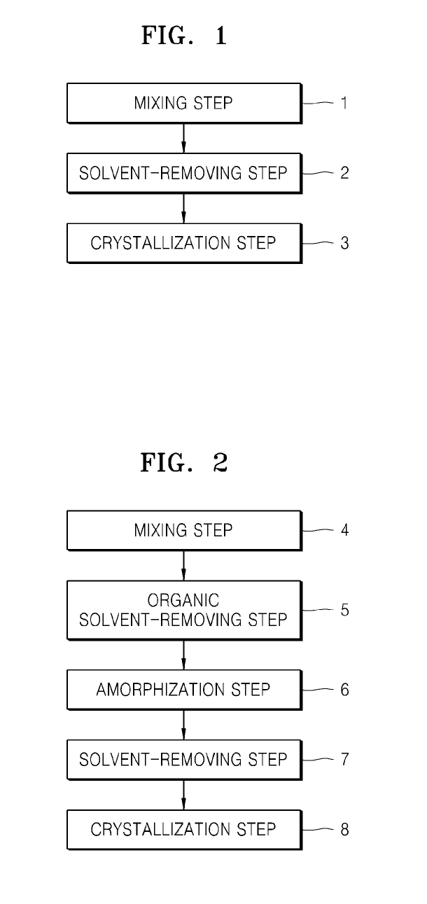

FIG. 1 represents a flowchart of a method of preparing a sulfide solid electrolyte, according to an embodiment.

Sulfide Solid Electrolyte]

A sulfide solid electrolyte according to an embodiment includes a sulfide product precipitated by a solution method using an organic solvent which will be described below. In an embodiment, the sulfide solid electrolyte contains a sulfide precipitate obtained by mixing at least Li₂S and P₂S₅ in an organic solvent including tetrahydrofuran (THF), a tetrahydrofuran compound substituted with a C1-C6 hydrocarbon group or a C1-C6 hydrocarbon group containing an ether group, or a C2-C7 non-cyclic ether compound (collectively—“tetrahydrofuran compound”). The sulfide precipitate may be an amorphous sulfide precipitate obtained by mixing at least Li₂S and P₂S₅ in a mixture of the organic solvent and an amorphization solvent added to the organic solvent. As used herein, the term “amorphization solvent” broadly means a solvent that produces an amorphous solid from a compound upon precipitation. In a preferred embodiment, no crystalline material is present in the precipitate. While the precipitating solid may proceed from a crystalline form to an amorphous form, it is not necessary; it is only necessary that the precipitate upon isolation is amorphous.

The sulfide solid electrolyte may include the tetrahydrofuran compound in an amount detectable by at least one analysis method selected from nuclear magnetic resonance (NMR) spectroscopy, infrared (IR) spectroscopy, elemental analysis (EA), and gas chromatography mass spectrometry (GC-MS). Thus, if the tetrahydrofuran compound is detected from a sulfide solid electrolyte, it indicates that the sulfide solid electrolyte is the electrolyte obtained according to the present embodiments.

The sulfide precipitate is a major component of the sulfide solid electrolyte used in an embodiment. The amount of the sulfide precipitate may be about 50 to about 100% by weight, for example, about 95 to about 100% by weight, based on the total weight of the sulfide solid electrolyte. The solid electrolyte used in an embodiment may further include another lithium ion conductor, such as Li₃N, lithium super ionic conductor (LISICON), Li_{3+y}PO₄₋ₓNₓ (LIPON), Li₃₋₂₅Ge_{0.25}P_{0.75}S₄ (Thio-LISICON), Li₂S, Li₂S—SiS₂, Li₂S—GeS₂, Li₂S—B₂S₅, Li₂S—Al₂S₅, and Li₂O—Al₂O₃—TiO₂—P₂O₅ (LATP), in addition to the sulfide precipitate according to this embodiment.

The sulfide precipitate is a sulfide prepared by mixing Li₂S and P₂S₅ as starting materials. Ion conductivity of the sulfide precipitate may be about 10⁻⁵ to about 10⁻² Siemens per centimeter (S/cm), for example, about 10⁻⁴ to about 10⁻² S/cm. The sulfide solid electrolyte, including the sulfide precipitate as a major component, according to an embodiment may be suitable for solid state batteries, such as all-solid-state secondary batteries.

Ion conductivity of the sulfide precipitate is determined based on the composition, crystallinity, and particle diameter of the prepared sulfide. An average particle diameter of the sulfide solid electrolyte may be about 0.1 to about 100 micrometers (μm), for example, about 1 to about 50 μm. The average particle diameter is an average of particle diameters of fifty sulfide particles randomly selected.

According to an embodiment, the sulfide solid electrolyte may be an amorphous material or crystalline material as long as it has desired ion conductivity. Whether the sulfide solid electrolyte is an amorphous material or crystalline material may be identified by measuring X-ray diffraction pattern using CuKα line. The amorphous material, as used herein, may not only refer to an amorphous material showing a broad halo diffraction pattern of gradual arc, but may also refer to a crystallite showing a small and sharp peak in the broad halo diffraction pattern. The crystalline material, as used herein, refers to a material having only a sharp peak in the X-ray diffraction pattern, with the broad halo diffraction pattern disappeared. The sulfide precipitate may be an amorphous material including at least one compound selected from Li₃PS₄, Li₄P₂S₆, and Li₄P₂S₇. Alternatively, the sulfide precipitate may be a crystalline material including at least one compound selected from Li₃PS₄, Li₄P₂S₆, and Li₄P₂S₇. The amorphous or crystalline sulfide precipitate may be Li₇P₃S₁₁, i.e., a composite crystal of Li₃PS₄ and Li₄P₂S₇.

The sulfide precipitate may further include at least one compound selected from GeS₂, SiS₂, P₂S₃, P₂O₅, SiO₂, B₂S₃, Al₂S₃, B₂O₃ and Al₂S₅. For example, when Li₂S and P₂S₅ are mixed in the organic solvent, at least one compound selected from GeS₂, SiS₂, P₂S₃, P₂O₅, SiO₂, B₂S₃, Al₂S₃, B₂O₃ and Al₂S₅ may further be added to the mixture. That is, the sulfide solid electrolyte according to an embodiment may be represented by Li₂S—SiS, Li₂S—GeS₂, Li₂S—P₂S₅—SiS₂, Li₂S—P₂S₅—GeS₂, and the like. The sulfide solid electrolyte may have improved ion conductivity by including at least one of the above additional components.

The sulfide solid electrolyte having predetermined ion conductivity, obtained based on a desired average particle diameter, crystallinity, and composition, may be prepared by adjusting the amounts of the starting materials, mixing conditions, a method of removing the organic solvent, and sintering conditions of the precipitate. Hereinafter, a method of preparing a sulfide solid electrolyte, according to an embodiment, will be described in detail.

Method of Preparing Sulfide Solid Electrolyte

According to an embodiment, a method of preparing a sulfide-based solid electrolyte includes a mixing step using an organic solvent that will be described further later, and a solvent-removing step. The method may further include a crystallization step.

In an embodiment, the method of preparing a sulfide solid electrolyte includes a mixing step in which at least Li₂S and P₂S₅ are mixed in an organic solvent comprising a tetrahydrofuran compound optionally substituted with a C1-C6 hydrocarbon group or a C1-C6 hydrocarbon group containing an ether group, or a C2-C7 non-cyclic ether compound, to obtain a sulfide precipitate, and a solvent-removing step in which the organic solvent is removed from the sulfide precipitate by drying the sulfide precipitate.

FIG. 1 represents a flowchart of a method of preparing a sulfide solid electrolyte, according to an embodiment. In FIG. 1, 1 indicates a mixing step, 2 indicates a solvent-removing step, and 3 indicates a crystallization step.

Mixing Step

In the mixing step, at least Li₂S and P₂S₅ are added to an organic solvent as starting materials, and the mixture is stirred. The organic solvent may be unsubstituted tetrahydrofuran (THF), a tetrahydrofuran compound optionally substituted with a C1-C6 hydrocarbon group or a C1-C6 hydrocarbon group containing an ether group, or a C2-C7 non-cyclic ether compound. The tetrahydrofuran compound may be a derivative of tetrahydrofuran represented by Formula 1 below.

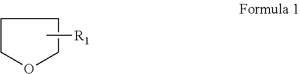

In Formula 1, R₁ is a C1-C6 alkyl group or an —X—O—Y group, wherein X is a C0-C3 alkylene group, and Y is a C1-C3 alkyl group. For example, R₁ may be a C1-C3 alkyl group. X may be a C0-C2 alkylene group, for example, a single bond (CO), a methylene group (C1), or an ethylene group (C2). Y may be, for example, a methyl group (C1), an ethyl group (C2), or a propyl group (C3).

The C2-C7 non-cyclic ether compound may be represented by Formula 2 below.

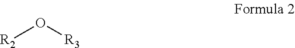

In Formula 2, R₂ and R₃ are each independently a C1-C3 alkyl group, a C3-C5 cycloalkyl group, a phenyl group or an —X′—O—Y′ group, wherein X′ is a C1-C3 alkylene group, and Y′ is a C1-C3 alkyl group. Here, R₂ and R₃ are not simultaneously the —X′—O—Y′ group. R₂ and R₃ may be each independently a methyl group (C1), an ethyl group (C2), an isopropyl group (C3), an n-propyl group (C3), a cyclopropyl group (C4), a cyclobutyl group (C4), or a cyclopentyl (C5) group. When R₂ or R₃ are the —X′—O—Y′ group, X′ may be a methylene group (C1), an ethylene group (C2), an isopropylene group (C3), or an n-propylene group (C3), and Y′ may be a methyl group (C1), an ethyl group (C2), an isopropyl group (C3), or an n-propyl group (C3). Here, R₂ and R₃ are not simultaneously the —X′—O—Y′ group, and only one of the R₂ and R₃ can be the —X′—O—Y′ group.

As the mixing step of the starting materials proceeds, a sulfide is precipitated from a reaction at a solid-liquid interface between Li₂S particles and P₂S₅ dissolved in the organic solvent. The sulfide precipitate is a sulfide included in the amorphous sulfide solid electrolyte according to the present embodiment. As the particle diameter of the Li₂S decreases, a specific surface area also increases. As the specific surface area increases, a size of the solid-liquid interface increases and the amount of sulfide precipitate tends to increase. The average particle diameter of Li₂S may be about 0.1 to about 100 μm, for example, about 0.1 to about 10 μm.

Tetrahydrofuran, the tetrahydrofuran compound and the C2-C7 non-cyclic ether compound contained in the organic solvent have a bulky and random chemical structure. A sulfide precipitated from this organic solvent tends to have an irregular structure and a non-uniform atomic configuration. As a result, it facilitates production of an amorphous sulfide. The amorphous sulfide may have an ion conductivity of about 10⁻⁵ to about 10⁻³ S/cm, for example, about 10⁻⁴ to about 10⁻³ S/cm. Thus, the ion conductivity of the amorphous sulfide is sufficiently high for the sulfide solid electrolyte.

While not wanting to be bound by theory, it is understood that when Li₂S that is a starting material is added to the organic solvent, the bulky organic solvent molecules prevent the introduction of lithium atoms contained in Li₂S into the chemical structure of the organic solvent. Thus, the solvation of the precipitated sulfide in the organic solvent may be suppressed. The sulfide, to which the organic solvent is attached, has an ion conductivity that is insufficient for the solid electrolyte. According to an embodiment, since the attachment of the organic solvent to the sulfide may be suppressed or inhibited, a sulfide solid electrolyte having high ion conductivity may be prepared. In addition, when the precipitated sulfide does not have desired ion conductivity, the ion conductivity of the sulfide may be improved by removing the organic solvent in the solvent-removing step which will be described later.

Examples of the tetrahydrofuran compound used in an embodiment include, but are not limited thereto, methyl tetrahydrofuran, such as 2-methyl tetrahydrofuran, ethyl tetrahydrofuran, such as 2-ethyl tetrahydrofuran, propyl tetrahydrofuran, such as 2-propyl tetrahydrofuran, methoxy tetrahydrofuran, such as 2-methoxy tetrahydrofuran, methoxymethyl tetrahydrofuran, such as 2-(methoxymethyl) tetrahydrofuran, and ethoxymethyl tetrahydrofuran, such as 2-(ethoxymethyl) tetrahydrofuran. Examples of the ether compound include, but are not limited thereto, dimethyl ether, diethyl ether, dipropyl ether, dimethoxymethane, dimethoxy ethane (DME), such as 1,1-dimethoxy ethane and 1,2-dimethoxy ethane, diethoxy ethane (DEE) such as 1,1-diethoxy ethane and 1,2-diethoxy ethane, cyclopropyl methyl ether, methoxy benzene, cyclopropyl ethyl ether, cyclopentyl methyl ether (CPME), and diisopropyl ether. In addition, the organic solvent may have a moisture content of 50 parts per million (ppm) (by weight) or less. Since this organic solvent has a high volatility, it may be easily removed from the sulfide.

According to the preparation method described in this embodiment, the organic solvent may be used alone. Alternatively, a combination of two or more organic solvents may be used.

In addition to Li₂S and P₂S₅, at least one compound selected from GeS₂, SiS₂, P₂S₃, P₂O₅, SiO₂, B₂S₃, Al₂S₃, B₂O₃ and Al₂S₅ may further be added to the organic solvent. Accordingly, the ion conductivity of the precipitate may be improved. The additives may be used alone or a combination of at least two additives may be used.

A molar ratio of Li₂S to P₂S₅ added to the organic solvent is x:1-x. In this regard, x may be any number satisfying 0.1<x<0.9, for example, 0.7<x<0.8. When the starting materials are added thereto in the molar ratio described above, a sulfide solid electrolyte having high ion conductivity may be prepared. If x is equal to or less than 0.1, the obtained sulfide may have insufficient ion conductivity for solid electrolyte. In addition, if x is equal to or greater than 0.9, the obtained sulfide may have insufficient ion conductivity for the solid electrolyte. Furthermore, a total concentration of Li₂S and P₂S₅ in the organic solvent may be in the range of about 0.012 to about 0.075 grams per milliliter (g/ml), for example, about 0.025 to about 0.05 g/ml.

The molar ratio of the starting materials is the same as a molar ratio of the components of the sulfide precipitate obtained therefrom. Thus, a desired composition ratio of the sulfide solid electrolyte may be obtained by adjusting a mixing ratio of the starting materials, such that the molar ratio of the starting materials is the same as the composition ratio of the sulfide. In addition, the sulfide precipitated in the mixing step may include at least one compound selected from Li₃PS₄, Li₄P₂S₆, and Li₄P₂S₇. By adjusting the mixing ratio, one type of sulfide or multiple types of sulfides may be precipitated. For example, when Li₃PS₄ is prepared, Li₂S and P₂S₅ are mixed in a molar ratio of 0.75:0.25. The amorphous Li₃PS₄ has an ion conductivity of about 10⁻⁴ S/cm. In addition, in order to precipitate Li₃PS₄ and Li₄P₂S₇ in a molar ratio of 1:1, Li₂S and P₂S₅ are mixed in a molar ratio of 0.70:0.30. A sulfide obtained by crystallizing the mixture of Li₃PS₄ and Li₄P₂S₇ has an ion conductivity of about 10⁻³ S/cm.

The starting materials may be mixed by stirring. In this regard, the mixing may be performed by adding the organic solvent to a reactor equipped with a stirring blade, adding the starting materials to the organic solvent, and rotating the stirring blade. A temperature of the organic solvent may be about 15 to about 60° C., for example, about 25 to about 40° C. Accordingly, the starting materials may be sufficiently mixed, and the sulfide may be efficiently precipitated. When the amount of the precipitate no longer increases, the stirring is stopped. The stirring time may be about 0.5 to about 10 days, for example, about 0.5 to about 5 days. According to another method, the mixing may be performed by adding the starting materials and the organic solvent to a ball mill and ball milling after sealing the ball mill.

When the sulfide precipitate has a crystalline structure, an amorphization solvent, especially C2-C7 non-cyclic ether compound, such as dimethoxy ethane, diethoxy ethane, and anisole may be added to the organic solvent to obtain amorphous sulfide material, especially, as in the case of Li₃PS₄, when the amorphous phase gives higher ionic conductivity than that of crystalline phase.

Solvent-Removing Step

When the sulfide precipitated in the mixing step is solvated with the organic solvent, the organic solvent may be removed from the sulfide. Thus, the reduction in ion conductivity caused by the solvation may be prevented, and a sulfide having a desired ion conductivity may be prepared.

In this step, the sulfide is recovered from the reactor by using a filter or a rotary evaporator. In addition, the organic solvent remaining in the sulfide may be removed by vacuum drying, such as vacuum calcination. Since the sulfide may react with moisture in the air, the sulfide in this method is prevented from being in contact with the air. In the vacuum calcination step, calcination temperature and calcination time may be appropriately adjusted in accordance with the types of the organic solvent. The calcination temperature may be about 50 to about 200° C., for example, about 80 to about 180° C. The calcination time may be about 30 to about 180 minutes, for example about 100 to about 180 minutes. When the calcination temperature is less than 50° C. or the calcination time is less than 30 minutes, the organic solvent may not be sufficiently removed, so that the sulfide may have low ion conductivity. When the calcination temperature is greater than 200° C., unintended crystallization of the sulfide may be caused, or transition to a phase with low ion conductivity may occur.

By performing the mixing step or by performing both the mixing step and the organic solvent-removing step, an amorphous sulfide solid electrolyte such as Li₃PS₄ and Li₄P₂S₇ may be prepared. Typically, the sulfide solid electrolyte may have an ion conductivity of about 10⁻⁵ to about 10⁻² S/cm and an average particle diameter of about 0.1 to about 50 μm.

Crystallization Step

According to an embodiment, the amorphous sulfide solid electrolyte prepared by the mixing step or the organic solvent-removing may be crystallized by sintering. In this step, the sulfide, from which the organic solvent is removed, is heat-treated in an inert atmosphere such as argon or nitrogen, or in a vacuum. The sulfide prepared according to this method has a uniform atomic configuration, and is crystalline. Thus, the crystalline sulfide having an ion conductivity of about 10⁻³ to about 10⁻² S/cm may be prepared. Particularly, a composite crystal of Li₃PS₄ and Li₄P₂S₇ may be prepared. The heat treatment temperature during the heat treatment may be in the range of about 180 to about 350° C., for example, about 200 to about 300° C. When the heat treatment temperature is out of the range described above, the ion conductivity may be considerably decreased. The heat treatment time may be about 30 to about 180 minutes, for example, about 60 to about 120 minutes. When the heat treatment time is out of the range described above, the ion conductivity may be considerably decreased.

In the method of preparing the sulfide solid electrolyte according to an embodiment in which the organic solvent described above is used, a sulfide having a desired composition may conveniently be precipitated by adjusting a mixing ratio of the starting materials. According to the method, the amount of the organic solvent and the amounts of the starting materials may be readily increased by scaling up the volume of the reactor. Accordingly, a large amount of a sulfide having high ion conductivity may be precipitated. In addition, since the organic solvent used herein has high volatility, it is readily removed from the sulfide. Thus, the ion conductivity of the precipitated sulfide may further be improved. According to the embodiments, the sulfide solid electrolyte may be conveniently produced on a large scale with the use of a specific organic solvent and simple process with low manufacturing costs.

In the present embodiment described herein, in the mixing step, an amorphous sulfide precipitate may be obtained by mixing Li₂S and P₂S₅ in a mixed solvent of the organic solvent and an amorphization solvent may be added to the organic solvent. The amorphization solvent may be a compound which has a donor number from 18 to 28, and a boiling point which is equal to or greater than the boiling point of the organic solvent. The donor number is a quantitative measure of a solvent parameter developed by V. Gutmann, and it is a value obtained by measuring a coordination stabilization enthalpy to antimony pentachloride (SbCl₅) in 1,2-dichloroethane in units of kilocalories per mole (kcal/mol). As the value of donor number increases, affinity towards lithium ions, or a sulfide also increases. In the mixing step, an amorphization solvent may infiltrate into the structure of a sulfide by mixing Li₂S and P₂S₅ in a mixture of the organic solvent and an amorphization solvent. As a result, the crystals of the sulfide collapse by the effect of the amorphization solvent, thereby forming an amorphous sulfide precipitate after the mixed solvent are removed in the solvent-removing step. In addition, in the crystallization step performed after the solvent-removing step, the amorphous sulfide precipitate is crystallized, thereby causing the atomic arrangement of the sulfide to become more regular and the ionic conductivity of the crystalline sulfide thus obtained to increase.

In the present embodiment, the boiling points of the amorphization solvent and the organic solvent indicate a boiling point under a reduced pressure in the vacuum calcination step. By making the boiling point of the amorphization solvent equal to or greater than the boiling point of the organic solvent, it is possible to evaporate the organic solvent preferentially in the vacuum calcination step. By this, much of the amorphization solvent infiltrates into the structure of the sulfide making an amorphous sulfide material to precipitate readily. The amorphization solvent may be at least one selected from dimethoxy ethane, diethoxy ethane, and anisole, but is not limited thereto.

### Another Embodiment

Now, another illustrative embodiment will be described below. The sulfide solid electrolyte according to the present embodiment includes a sulfide product precipitated by a solution method using a specific organic solvent. FIG. 2 represents a flowchart of a method of preparing a sulfide solid electrolyte according to the present embodiment. With reference to FIG. 2, the present embodiment will be described in such a manner that aspects different from the previous embodiment are mainly explained. The method of preparing a sulfide solid electrolyte according to the present embodiment includes a mixing step using a specific organic solvent, an organic solvent-removing step, an amorphization step, a solvent-removing step, and a crystallization step. This embodiment is different from the previous embodiment in that the organic solvent-removing step and the amorphization step are performed between the mixing step and the solvent-removing step. In FIG. 2, 4 indicates a mixing step, 5 indicates an organic solvent-removing step, 6 indicates an amorphization step, 7 indicates a solvent-removing step, and 8 indicates a crystallization step. The mixing step, the solvent-removing step, and the crystallization step are the same steps as in the previous embodiment.

Organic Solvent-Removing Step

In the organic solvent-removing step, at least a part of the organic solvent is removed by stirring the sulfide solid electrolyte containing the sulfide precipitate obtained in the mixing step in the organic solvent while heating the sulfide solid electrolyte under an atmospheric pressure or under a reduced pressure. Alternatively, at least a part of the organic solvent may be removed by stirring the sulfide solid electrolyte containing the sulfide precipitate obtained in the organic solvent at a room temperature. The conditions of the removing the organic solvent are not limited as long as the organic solvent can be distilled out without the polymerization and/or decomposition of the sulfide. This step may be carried out while appropriately adjusting the pressure within the vessel and the temperature of the liquid with the vessel. As the vessel used to distill out the organic solvent, a distillation apparatus, such as a rotary evaporator, can be used. The distillation apparatus can appropriately adjust the pressure and the temperature within the vessel.

Amorphization Step

In the amorphization step, after the organic solvent is removed, the sulfide powder is removed therefrom, added to the amorphization solvent, and stirred. The amorphization solvent may be a compound which has a donor number from 18 to 28, and a boiling point which is equal to or greater than the boiling point of the organic solvent. In an embodiment, the amorphization solvent may be at least one selected from dimethoxy ethane, diethoxy ethane, and anisole.

After the amorphization step, as in the previous embodiment, an amorphous sulfide material is obtained by removing the solvent in the solvent-removing step. Further, in the crystallization step performed after the solvent-removing step, the amorphous sulfide material is crystallized. While not wanting to be bound by theory, it is understood that in the crystallized product, the atomic arrangement of the sulfide are more regular and the ionic conductivity of the crystalline sulfide thus obtained is increased.

In the present embodiment, the organic solvent-removing step and the amorphization step are performed between the mixing step and the solvent-removing step. However, the present invention is not limited thereto, e.g., the organic solvent-removing step may be omitted. In this latter case, the amorphization solvent may be added to the organic solvent containing the sulfide solid electrolyte obtained after the mixing step and the resulting mixture may be stirred.

When the sulfide precipitate has a crystalline structure, amorphization step may be carried out by using the amorphization solvent, which can be at least one of C2-C7 non-cyclic ether compound, especially dimethoxy ethane, diethoxy ethane, and anisole. Especially, in the case of Li₃PS₄, the amorphous phase gives higher ionic conductivity than that of crystalline phase. Therefore, the amorphization step is required to obtain a sulfide electrolyte with high ionic conductivity. In this case the crystallization step would not be necessary. In addition, the C2-C7 non-cyclic ether compound having a donor number between 18 to 28, and a higher boiling point than the other organic solvent may be better to be chosen, because of their selective solvation onto the sulfide precipitate due to its high donor number. This strong solvation may prevent crystallization during drying process. Also, their high boiling temperature may prevent the solvation exchange, even if some residual organic solvents are remained after a first drying procedure.

Solid State Battery

Hereinafter, a solid state battery according to an exemplary embodiment will be described in detail.

The solid state battery includes a positive electrode, a negative electrode, and a solid electrolyte layer interposed between the positive electrode and the negative electrode. For example, the solid state battery is a solid state battery including a positive electrode having a positive active material, a negative electrode having a negative active material, and a solid electrolyte layer interposed between the positive electrode and the negative electrode. Here, the solid electrolyte layer includes the sulfide solid electrolyte. The solid state battery may be an all-solid-state secondary battery. Since the sulfide precipitate having high ion conductivity is used in at least one of the solid electrolyte layer, the positive electrode, and the negative electrode in the solid state battery, battery performance such as discharge capacity and cycle characteristics may be improved.

The positive electrode includes a positive electrode active material having a layered structure, which allows reversible intercalation and deintercalation of lithium ions. The positive electrode active material may be any material allowing reversible intercalation and deintercalation of lithium ions without limitation. Examples of the positive electrode active material include lithium cobalt oxide (LCO), lithium nickel oxide, lithium nickel cobalt oxide, lithium nickel cobalt aluminum oxide (NCA), lithium nickel cobalt manganese oxide (NCM), lithium manganate, lithium iron phosphate, nickel sulfide, copper sulfide, sulfur, iron oxides, vanadium oxides, and the like. The positive electrode active material may be used alone or a combination of at least two positive electrode active materials may be used.

For example, the positive electrode active material may be any lithium-containing metal oxides commonly used in the art without limitation. For example, one or more composite oxides of lithium and metals selected from cobalt, manganese, nickel, and any combination thereof may be used. Examples of the composite oxides include one of the compounds represented by the following formulas: LiₐA_{1-b}B_{b}D₂ (where 0.90≦a≦1 and 0≦b≦0.5); LiₐE_{1-b}B_{b}O_{2-c}D_{c} (where 0.90≦a≦1, 0≦b≦0.5, and 0≦c≦0.05); LiE_{2-b}B_{b}O_{4-c}D_{c} (where 0≦b≦0.5 and 0≦c≦0.05); LiₐNi_{1-b-c}Co_{b}B_{c}D_{α} (where 0.90≦a≦1, 0≦b≦0.5, 0≦c≦0.05, and 0<α<2); LiₐNi_{1-b-c}Co_{b}B_{c}O_{2-α}F₂ (where 0.90≦a≦1, 0≦b≦0.5, 0≦c≦0.05, and 0<α<2); LiₐNi_{1-b-c}Co_{b}B_{c}O_{2-α}F₂ (where 0.90≦a≦1,0≦b≦0.5, 0≦c≦0.05, and 0<α<2); LiₐNi_{1-b-c}Mn_{b}B_{c}D_{α} (where 0.90≦a≦1,0≦b≦0.5, 0≦c≦0.05, and 0<α≦2); LiₐNi_{1-b-c}Mn_{b}B_{c}O_{2-α}F_{α} (where 0.90≦a1, 0≦b≦0.5, 0≦c≦0.05, and 0<α<2); LiₐNi_{1-b-c}Mn_{b}B_{c}O_{2-α}F₂ (where 0.90≦a <1, 0≦b≦0.5, 0≦c≦0.05, and 0<α<2); LiₐNi_{b}E_{c}G_{d}O₂ (where 0.90≦a≦1, 0b≦0.9, 0≦c≦0.5, and 0.001≦d≦0.1); LiₐNi_{b}Co_{c}Mn_{d}GeO₂ (where 0.90≦a≦1, 0≦b≦0.9, 0≦c≦0.5, 0≦d≦0.5, and 0.001≦e≦0.1); LiₐNiG_{b}O₂(where 0.90≦a ≦1 and 0.001≦b≦0.1); LiₐCoG_{b}0₂ (where 0.90≦a≦1 and 0.001≦b≦0.1); LiₐMnG_{b}O₂ (where 0.90≦a≦1 and 0.001≦≦b≦0.1); LiₐMn₂G_{b}O₄ (where 0.90≦a≦1 and 0.001≦b≦0.1); QO₂; QS₂; LiQS₂; V₂O₅; LiV₂O₅; LiIO₂; LiNiVO₄; Li (₃₄)J₂(PO₄)₃(0 ≦f≦2); Li_{(3-f)}Fe₂(PO₄)₃ (0≦f≦2); and LiFePO₄.

In the above formulas, A is nickel (Ni), cobalt (Co), manganese (Mn), or a combination thereof; B is aluminum (Al), Ni, Co, Mn, chromium (Cr), iron (Fe), magnesium (Mg), strontium (Sr), vanadium (V), rare earth elements, or a combination thereof; D is oxygen (O), fluorine (F), S, P, or a combination thereof; E is Co, Mn, or a combination thereof; F is F, S, P, or a combination thereof; G is Al, Cr, Mn, Fe, Mg, lanthanum (La), cerium (Ce), Sr, V, or a combination thereof; Q is titanium (Ti), molybdenum (Mo), Mn, or a combination thereof; I is Cr, V, Fe, scandium (Sc), yttrium (Y), or a combination thereof; and J is V, Cr, Mn, Co, Ni, copper (Cu), or a combination thereof. For example, the positive electrode active material may include LiCoO₂, LiMnₓO₂ₓ (x=1 and 2), LiNi₁₋ₓMnₓO₂ₓ (0<x<1), LiNi_{1-x-y}CoₓMn_{y}O₂ (0≦x≦0.5 and 0≦y≦0.5), FePO₄, and the like. More particularly, the compound may be LiNiₓM1_{y}M2_{z}O₂ (0.5<x<0.9, 0.1<y<0.6, and 0.01<z<0.2, M1 is Co and/or Mn, and M2 is at least one of Al, Mg, and Ti), or the like. In a lithium-transition metal composite oxide in which M2 is Al, Mg, or Ti, these elements serve as a pillar supporting a layered structure of the composite oxide. Thus the layered structure of the composite oxide may be stably maintained even though intercalation and deintercalation of lithium ions are repeated.

A compound having a coating layer disposed on the above-described compounds may be used, or a compound may be used by mixing the above-described compounds and the compound having a coating layer. The coating layer may include a compound of a coating element such as an oxide, hydroxide, oxyhydroxide, oxycarbonate, or hydroxycarbonate of a coating element. The compound constituting the coating layer may be amorphous or crystalline. Examples of the coating element included in the coating layer may be Mg, Al, Co, potassium (K), sodium (Na), calcium (Ca), silicon (Si), Ti, V, tin (Sn), germanium (Ge), gallium (Ga), boron (B), arsenic (As), zirconium (Zr), and mixtures thereof. Any suitable coating method may be used for a process of forming a coating layer as long as coating may be performed by a method (e.g., spray coating, or dipping) that does not adversely affect the physical properties of the positive electrode active material due to using such coating elements on the above-described compounds.

In particular, the positive electrode active material may be a lithium salt of transition metal oxide having a layered rock-salt type structure among the above exemplary positive electrode active materials. In the present specification, the expression “layered” denotes a shape of a thin sheet, and the expression “rock-salt type structure” denotes a sodium chloride-type structure as one of crystal structures in which face-centered cubic lattices respectively formed of anions and cations are shifted by only a half of the side of each unit lattice. Examples of the lithium salt of transition metal oxide having a layered rock-salt type structure may be lithium salts of ternary transition metal oxides expressed as Li_{1-y-z}NiₓCo_{y}Al_{z}O₂ (NCA) or Li_{1-y-z} NiₓCo_{y}Mn_{z}O₂ (NCM) (wherein 0<x<1, 0<y<1, 0<z<1, x+y+z=1).

The negative electrode includes a negative electrode active material allowing reversible intercalation and deintercalation of lithium ions. The negative electrode active material may be any material allowing intercalation and deintercalation of lithium ions without limitation. For example, the negative electrode active material may include: lithium metal; a transition metal oxide such as Li₄/₃Ti_{5/3}O₄; and a carbonaceous material such as artificial graphite, graphite carbon fibers, resin-sintered carbon, carbon grown by vapor-phase thermal decomposition, coke, mesophase carbon microbeads (MCMB), furfuryl alcohol resin-sintered carbon, polyacenes, pitch-based carbon fibers (PCF), vapor grown carbon fibers, natural graphite, and non-graphitizable carbon. The negative electrode active material may have a layered structure. The negative electrode active material may be used alone or in a combination of at least two thereof.

In addition to either the positive or negative active materials in powder form, respectively, the positive and negative electrodes may include additives such as conductive agents, binders, electrolytes, fillers, dispersing agents, and ion conductors in appropriate ratios.

Examples of the conductive agent include graphite, carbon black, acetylene black, ketjen black, carbon fibers, metal powders, and the like. Examples of the binder include acrylic resins, polytetrafluoroethylenes (PTFE), polyvinylidene fluorides (PVDF), polyethylenes, and the like. Examples of the electrolyte include an inorganic solid electrolyte including the sulfide solid electrolyte layer according to an aspect.

The positive electrode or negative electrode may be prepared by the following methods. For example, the positive electrode or negative electrode may be prepared by preparing a mixture of the active material and various additives as described above and compressing the mixture into pellets having a high density and a great thickness by using a hydraulic press. Alternatively, the positive electrode or the negative electrode may be prepared by adding water or a solvent such as an organic solvent into the mixture described above to prepare a slurry or paste, coating the slurry or paste on a current collector by using a doctor blade, or the like, drying the coating, and pressing the dried coating using a roll press.

The current collector may be a plate or foil that is formed of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Alternatively, the positive electrode or the negative electrode may be prepared by press molding the mixture to form pellets without using the binder. In addition, if metal or an alloy thereof, such as Li metal, is used as the negative active material, a metal sheet thereof may be used as the negative electrode.

The solid electrolyte layer includes the lithium ion conductor as an inorganic solid electrolyte. The lithium ion conductor includes an inorganic solid electrolyte including the sulfide solid electrolyte according to an aspect. In addition to the sulfide solid electrolyte according to an aspect, the lithium ion conductor may further include any lithium ion conductors commonly used in the art, for example, Li₃N, LISICON, Li_{3+y}PO₄₋ₓNₓ (UPON), Li_{3.25}Ge_{0.25}P_{0.75}S₄ (Thio-LISICON), Li₂S, Li₂S—P₂S₅, Li₂S—SiS₂, Li₂S—GeS₂, Li₂S—B₂S₅, Li₂S—Al₂S₅, Li₂O—Al₂O₃—TiO₂—P₂O₅ (LATP), and the like. The inorganic compound may have a crystalline, amorphous, glass phase, or a glass ceramic structure. Among these inorganic solid electrolytes, the sulfide solid electrolyte according to an aspect may suitably be used.

The solid electrolyte layer may further include a binder in addition to the inorganic solid electrolyte. The binder may be a nonpolar resin not having a polar functional group. Thus, the binder may be inactive in a solid electrolyte having high reactivity, particularly, a sulfide solid electrolyte. An amount ratio of the inorganic solid electrolyte to the binder is not particularly limited. For example, the amount of the inorganic solid electrolyte including the sulfide solid electrolyte may be in the range of about 95 to about 99.9% by weight based on the total weight of the electrolyte layer, and the amount of the binder may be in the range of about 0.5 to about 5% by weight based on the total weight of the electrolyte layer.

The solid state battery may further include an adhesive layer disposed between the positive electrode layer and its current collector and/or between the negative electrode layer and its current collector. The adhesive layer strongly binds the positive electrode layer and the negative electrode layer to their current collectors. The adhesive layer may include a conductive material, a nonpolar binder resin not having a polar function group reactive to a solid electrolyte, for example, a sulfide solid electrolyte and a polar binder resin having a polar functional group, thus having a high binding ability to a current collector.

### EXAMPLES

The present invention will be described in more detail, according to the following examples and comparative examples. However, the following examples are merely presented to exemplify the present invention, and the scope of the present disclosure is not limited thereto.

### Example 1

0.575 g of Li₂S and 0.931 g of P₂S₅ were added to 40 ml of dimethoxy ethane (DME), as an organic solvent, contained in a 50 ml beaker in a glove box under an Ar atmosphere, and the mixture was stirred at room temperature overnight. The amount of Li₂S in the organic solvent was 75 mol %, and the amount of P₂S₅ was 25 mol %. After the reaction was terminated, the organic solvent was removed by distillation by using a rotary evaporator at about 35° C. Powders obtained therefrom were dried in a vacuum at about 180° C. for about 2 hours to completely remove the remaining organic solvent. These processes were all performed under the Ar atmosphere.

The structure analysis of the white powders obtained therefrom was performed using a powder X-ray diffraction apparatus and a Raman spectrophotometer. The white powders were found to be amorphous Li₃PS₄ including some crystallites thereof. As a result of the structure analysis, the Li₃PS₄ prepared in this Example was a sulfide having high purity and not including Li₄P₂S₆ and the like. The powders of Li₃PS₄ were molded in pellets and sandwiched with a stainless steel electrode to measure ion conductivity. The measured ion conductivity was 2×10⁻⁵ S/cm. A total processing time for the synthesis of the amorphous Li₃PS₄ was 2 days.

### Example 2

0.489 g of Li₂S and 1.011 g of P₂S₅ were added to 40 ml of DME, as an organic solvent, contained in a 50 ml beaker in a glove box under an Ar atmosphere, and the mixture was stirred at room temperature overnight. The amount of Li₂S in the organic solvent was 70 mol %, and the amount of P₂S₅ was 30 mol %. After the reaction was terminated, the organic solvent was removed by distillation by using a rotary evaporator at about 35° C. Powders obtained therefrom were dried in a vacuum at about 180° C. for about 2 hours to completely remove the remaining organic solvent. The dried powders were heat-treated at about 250° C. for about 2 hours to crystalize the powders. These processes were all performed under the Ar atmosphere.

The structure analysis of the obtained crystals was performed, and ion conductivity was measured in the same manner as in Example 1. The crystals were found to be Li₇P₃S₁₁, and the ion conductivity thereof was 3×10⁻⁴ S/cm. A total processing time for the synthesis of the Li₇P₃S₁₁ crystals was 2 days.

### Example 3

0.575 g of Li₂S and 0.931 g of P₂S₅ were added to 40 ml of DME, as an organic solvent, contained in a 50 ml beaker in a glove box under an Ar atmosphere, and the mixture was stirred at room temperature overnight. The amount of Li₂S in the organic solvent was 75 mol %, and the amount of P₂S₅ was 25 mol %. After the reaction was terminated, the organic solvent was removed by distillation by using a rotary evaporator at about 35° C.

A total of 45 ml consisting of 15 ml of DME, 15 ml of diethoxy ethane (DEE), and 15 ml of anisole was added to the powders after the distillation-out step, and the mixture was stirred at room temperature overnight to amorphize the powders. After the completion of the amorphization, the organic solvent was removed by distillation by using a rotary evaporator at about 150° C. The powders obtained therefrom were dried in a vacuum at about 180° C. for about 2 hours to completely remove the remaining organic solvent. These processes were all performed under the Ar atmosphere.

The structure analysis of the obtained powders was performed, and ion conductivity was measured in the same manner as in Example 1. The powders were found to be amorphous Li₃PS₄ not containing crystallites thereof. The powders of Li₃PS₄ were molded in pellets and sandwiched with an indium electrode to measure ionic conductivity. The ion conductivity thereof was 2×10⁻⁴ S/cm. A total processing time for the synthesis of the Li₃PS₄ was 3 days.

### Example 4

0.575 g of Li₂S and 0.931 g of P₂S₅ were added to 40 ml of methyltetrahydrofuran (methyl THF), as an organic solvent, contained in a 50 ml beaker in a glove box under an Ar atmosphere, and the mixture was stirred at room temperature overnight. The amount of Li₂S in the organic solvent was 75 mol %, and the amount of P₂S₅ was 25 mol %. After the reaction was terminated, the organic solvent was removed by distillation by using a rotary evaporator at about 35° C. The crystal structure of the precipitation was verified using XRD. Since the crystalline Li₃PS₄ was assigned in the diffraction pattern, 15 ml of dimethoxy ethane, 15 ml of diethoxy ethane, and 15 ml of methoxy benzene were added to the crystalline precipitate in a 50 ml beaker to convert to the amorphous phase, and was stirred during overnight at room temperature. After the reaction was terminated, the organic solvents were removed by distillation by using a rotary evaporator at 150° C. Powders obtained therefrom were dried in a vacuum at about 180° C. for about 2 hours to completely remove the remaining organic solvent. These processes were all performed under the Ar atmosphere.

The structure analysis of the white powders obtained therefrom was performed using a powder X-ray diffraction device and a Raman spectrophotometer. The white powders were found to be amorphous Li₃PS₄. As a result of the structure analysis, the Li₃PS₄ prepared in this Example was a sulfide having high purity and not including Li₄P₂S₆ and the like. The powders of Li₃PS₄ were molded in pellets and sandwiched with a stainless steel electrode to measure ion conductivity. The measured ion conductivity was 2×10⁻⁴ S/cm. A total processing time for the synthesis of the amorphous Li₃PS₄ was 2 days.

### Comparative Example

0.575 g of Li₂S and 0.931 g of P₂S₅ were added to a stainless steel (SUS) pot, and two different types of balls with different diameters were added thereto to improve mixing efficiency. Under an Ar atmosphere, the pot was sealed, and milling was performed at about 350 revolutions per minute (rpm). The mixing was performed by repeating a ten minute milling process and a five minute recess. At intervals of three hours, samples were repeatedly taken out from the pot into a mortar where the samples were further mixed.

These processes were all performed under the Ar atmosphere. As a result of performing the structure analysis and measuring ion conductivity in the same manner as in Example 1, the white powders obtained therefrom were amorphous Li₃PS₄ and the ion conductivity thereof was 2×10⁻⁴ S/cm. With respect to the time taken for the processes, a total milling time was 40 hours and a total processing time for the milling process and recess time was 60 hours. A total processing time for the synthesis including the mixing process in the mortar was 120 hours (5 days).

In addition, when the sulfide solid electrolyte is to be produced on a large scale according to the method of a Comparative Example, the number of pots is increased, in general, in accordance with a desired amount of the product. Since the pot requires high electric power to be operated, power cost tends to increase in order to increase the number of pots.

TABLE 1

| | Added | Added | | | | | | |
|---|---|---|---|---|---|---|---|---|
| | amount of | amount of | | | | | Ionic | Total |
| | Li₂S | P₂S₅ | Organic | Amorphization | | | conductivity | processing |
| | (mol %) (g) | (mol %) (g) | solvent | solvent | Sulfide solid electrolyte | | (S/cm) | time |
| Example 1 | 75 mol % | 25 mol % | DME | — | Li₃PS₄ | Amorphous | 2 × 10⁻⁵ | 2 days |
| | 0.575 g | 0.931 g | | | | (including | | |
| | | | | | | crystallite) | | |
| Example 2 | 70 mol % | 30 mol % | DME | — | Li₇P₃S₁₁ | Crystalline | 3 × 10⁻⁴ | 2 days |
| | 0.489 g | 1.011 g | | | | | | |
| Example 3 | 75 mol % | 25 mol % | DME | DME, DEE, | Li₃PS₄ | Amorphous | 2 × 10⁻⁴ | 3 days |
| | 0.575 g | 0.931 g | | anisole | | | | |
| Example 4 | 75 mol % | 25 mol % | Methyl | — | Li₃PS₄ | Amorphous | 2 × 10⁻⁴ | 2 days |
| | 0.575 g | 0.931 g | THF | | | | | |
| Comparative | 75 mol % | 25 mol % | — | | Li₃PS₄ | Amorphous | 2 × 10⁻⁴ | 5 days |
| Example | 0.575 g | 0.931 g | | | | | | |

Referring to Table 1, the sulfide solid electrolytes prepared according to the embodiments have high ion conductivity in the range of about 10⁻⁵ to about 10⁻² S/cm. Thus, the sulfide solid electrolyte is suitable for solid electrolytes of lithium-ion secondary batteries. When the sulfide solid electrolyte is applied to a lithium-ion secondary battery, a positive electrode layer and a negative electrode layer are formed by mixing a positive electrode active material with the sulfide solid electrolyte and mixing a negative electrode active material with the sulfide solid electrolyte, respectively. A solid electrolyte layer, including the sulfide solid electrolyte, is interposed between the positive electrode layer and the negative electrode layer, thereby preparing the lithium-ion secondary battery.

According to the method of preparing a sulfide solid electrolyte, the sulfide solid electrolyte with high ion conductivity may be prepared within a short period of time. According to the method, the sulfide solid electrolyte may be conveniently produced on a large scale by scaling up the reactor. Since a complicated apparatus is not required, equipment may be enlarged with ease and low power cost. Although the reactor is scaled up, a manufacturing time may not be increased and manufacturing costs such as power cost may not be increased. That is, according to the embodiments, the sulfide solid electrolyte with high ion conductivity may be produced on a large scale with ease and low manufacturing costs.

As described above, according to the one or more of the above embodiments, a sulfide solid electrolyte having high ion conductivity may be produced on a large scale with low manufacturing costs.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present disclosure as defined by the following claims.

What is claimed is:

1. A sulfide solid electrolyte comprising a sulfide product prepared by mixing at least Li₂S and P₂S₅ in an organic solvent, wherein the organic solvent comprises a tetrahydrofuran compound optionally substituted with a C1-C6 hydrocarbon group or a C1-C6 hydrocarbon group comprising an ether group, or a C2-C7 non-cyclic ether compound.

2. The sulfide solid electrolyte of claim 1, wherein the sulfide product is an amorphous sulfide product obtained by mixing at least Li₂S and P₂S₅ in a mixture of the organic solvent and an amorphization solvent.

3. The sulfide solid electrolyte of claim 1, wherein the sulfide solid electrolyte comprises an amorphous sulfide product obtained by mixing the sulfide product with an amorphization solvent.

4. The sulfide solid electrolyte of claim 1, wherein the sulfide solid electrolyte comprises an amorphous sulfide product obtained by removing the organic solvent from the sulfide product, and mixing the sulfide product with an amorphization solvent.

5. The sulfide solid electrolyte of claim 2, wherein the amorphization solvent is a compound which has a donor number from 18 to 28, and a boiling point which is equal to or greater than the boiling point of the organic solvent.

6. The sulfide solid electrolyte of claim 5, wherein the amorphization solvent is at least one selected from dimethoxy ethane, diethoxy ethane, and anisole.

7. The sulfide solid electrolyte of claim 1, wherein the sulfide solid electrolyte comprises a sulfide compound obtained by heat treating the sulfide product at a temperature of about 50 to 200° C. for about 30 to 180 minutes.

8. The sulfide solid electrolyte of claim 1, wherein the sulfide solid electrolyte comprises a crystalline sulfide product obtained by heat treating the sulfide product at a temperature of about 50 to 200° C. for about 30 to 180 minutes, and further heat treating the sulfide product at a temperature of about 180 to 350° C. for about 30 to 180 minutes.

9. The sulfide solid electrolyte of claim 1, wherein the sulfide product comprises at least one selected from Li₃PS₄, Li₄P₂S₆, Li₄P₂S₇, and Li₇P₃S₁₁.

10. The sulfide solid electrolyte of claim 1, wherein a molar ratio of Li₂S to P₂S₅ is x:1-x, wherein x satisfies 0.1<x<0.9.

11. The sulfide solid electrolyte of claim 1, wherein the sulfide product further comprises at least one selected from GeS₂, SiS₂, P₂S₃, P₂O₅, SiO₂, B₂S₃, B₂O₃, Al₂S₃, and Al₂S₅.

12. A method of preparing a sulfide solid electrolyte, the method comprising
mixing at least Li₂S and P₂S₅ in an organic solvent, wherein the organic solvent comprises a tetrahydrofuran compound optionally substituted with a C1-C6 hydrocarbon group or a C1-C6 hydrocarbon group comprising an ether group, or a C2-C7 non-cyclic ether compound, to obtain a sulfide product; and
removing the organic solvent from the sulfide product by drying the sulfide product.

13. The method of claim 12, wherein the mixing at least Li₂S and P₂S₅ in an organic solvent comprises mixing at least Li₂S and P₂S₅ with a combination of the organic solvent and an amorphization solvent to obtain an amorphous sulfide product.

14. The method of claim 12, wherein a reacting of at least Li₂S and P₂S₅ in an organic solvent further comprises amorphization
contacting the sulfide product with an amorphization solvent to obtain an amorphous sulfide product.

15. The method of claim 14, wherein amorphization the contacting the sulfide product with an amorphization solvent is preceded by removing the organic solvent from the sulfide product.

16. The method of claim 12, wherein the removing the organic solvent from the sulfide product comprises heat-treating the sulfide product in vacuum at a temperature in the range of about 50 to about 200° C. for about 30 to about 180 minutes.

17. The method of claim 12, wherein the mixing at least Li₂S and P₂S₅ in an organic solvent comprises further comprises crystallizing the sulfide product from the organic solvent, and wherein the removing the organic solvent from the sulfide product comprises heat-treating the sulfide product at a temperature in the range of about 180 to about 350° C. for about 30 to about 180 minutes.

18. The method of claim 12, wherein the sulfide product is at least one selected from Li₃PS₄, Li₄P₂S₆, Li₄P₂S₇, and Li₇P₃S₁₁.

19. The method of claim 12, wherein a molar ratio of Li₂S to P₂S₅ is x:1-x, wherein x satisfies 0.1<x<0.9.

20. A solid state battery comprising
a positive electrode comprising a positive active material,
a negative electrode comprising a negative active material, and
a solid electrolyte layer interposed between the positive electrode and the negative electrode,
wherein the solid electrolyte layer comprises a sulfide solid electrolyte according to claim 1.
